(19) United States
(12) Patent Application Publication
(10) Pub. No.: US 2026/0229644 A1
(43) Pub. Date: Aug. 6, 2026

(54) POINT OF ASSEMBLY CELL ISOLATION BARRIER

(71) Applicant: GM Global Technology Operations LLC, Detroit, MI (US)

(72) Inventors: Andrew Stash Wolfe, Ferndale, MI (US); Ryan Patrick Hickey, Austin, TX (US); Loren Leann Racicot, Los Angeles, CA (US); Andrew A. Raftopoulos, Auburn Hills, MI (US); Chinmaya Patil, South Lyon, MI (US)

(73) Assignee: GM Global Technology Operations LLC, Detroit, MI (US)

(21) Appl. No.: 19/047,307

(22) Filed: Feb. 6, 2025

(51) Int. Cl. H01M 10/658; H01M 10/625; H01M 50/249; H01M 50/593

(52) U.S. Cl. CPC H01M 10/658; H01M 10/625; H01M 50/249; H01M 50/593; H01M 2220/20

(57) ABSTRACT

A battery cell includes a body extending between a first end and a second end, battery internals arranged in the body, and an insulation layer arranged on the body and extending between the first end and the second end, the insulation layer including one or more alignment features.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to battery cells and, more particularly, to insulating battery cells.

Electric vehicles (EVs) are an alternative to traditional internal combustion engine vehicles. A key component of EVs is a power reservoir, which functions as the main energy storage system. The power reservoir typically consists of one or more battery modules, each containing multiple battery cells that store and release electrical energy to power the vehicle. The power reservoir and, more particularly, the battery modules can include an insulative material that engages with the battery cells to help maintain thermal stability. For instance, the battery cells can be arranged in slots of an insulative honeycomb structure or an insulative material can be injected or poured into one of the battery modules to encapsulate the battery cells. Alternate systems and methods of insulating battery cells will be addressed by one or more aspects of the present disclosure.

### SUMMARY

In one configuration, a battery cell is provided and includes a body extending between a first end and a second end, battery internals arranged in the body, and an insulation layer arranged on the body and extending between the first end and the second end, the insulation layer including one or more alignment features.

The battery cell may include one or more of the following optional aspects. For example, the body can include a positive terminal and a negative terminal.

According to at least one aspect, the battery internals can include one or more cathode layers, one or more anode layers, and one or more separation layers arranged about a center pin that is arranged in the body and extends between the first end and the second end.

According to another aspect, the insulation layer can further include a first end and a second end spaced from the first end, and an inner wall and an outer wall spaced from the inner wall, the inner and outer walls extending between the first end and the second end of the insulation layer. The one or more alignment features can define a perimeter of the battery cell that is hexagonal.

According to at least one example, the first end of the insulation layer can be recessed with respect to the first end of the body and the second end of the insulation layer can be recessed with respect to the second end of the body.

According to another example, the first end of the insulation layer can overlap a portion of the first end of the body and the second end of the insulation layer can overlap a portion of the second end of the body.

According to at least one aspect, the first end of the insulation layer may share a first plane with the first end of the body and the second end of the insulation layer may share a second plane with the second end of the body.

According to another aspect, the alignment features of the insulation layer can include at least three sides.

According to one example, the alignment features of the insulation layer can define a perimeter that includes one continuous surface.

In another configuration, a battery module is provided and includes a base plate including an upper end and a lower end opposite of the upper end, one or more battery cells arranged on the upper end, the one or more battery cells including a body extending between a first end and a second end and including a sidewall that extends between the first end and the second end, battery internals arranged in the body, and an insulation layer arranged on the body and extending between the first end and the second end, the insulation layer including one or more alignment features.

The battery module may include one or more of the following optional aspects. For example, the insulation layer can further include a first end and a second end spaced from the first end, and an inner wall and an outer wall spaced from the inner wall, the inner and outer walls may extend between the first end and the second end of the insulation layer.

According to at least one aspect, the first end of the insulation layer can be recessed with respect to the first end of the body and the second end of the insulation layer can be recessed with respect to the second end of the body.

According to another aspect, the first end of the insulation layer can overlap a portion of the first end of the body and the second end of the insulation layer can overlap a portion of the second end of the body.

According to at least one example, the first end of the insulation layer can share a first plane with the first end of the body and the second end of the insulation layer can share a second plane with the second end of the body.

In another configuration, a vehicle is provided and includes a vehicle body extending between a first end and a second end, an electric motor coupled to the vehicle body, a power reservoir coupled to the vehicle body and communicatively coupled to the electric motor, the power reservoir including one or more battery modules and one or more battery cells arranged in each of the one or more battery modules. The one or more battery cells each include a body extending between a first end and a second end and including a sidewall that extends between the first end and the second end, battery internals arranged in the body, and an insulation layer arranged on the body and extending between the first end and the second end, the insulation layer including one or more alignment features.

The vehicle may include one or more of the following optional aspects. For example, the insulation layer can further include a first end and a second end spaced from the first end, and an inner wall and an outer wall spaced from the inner wall, the inner and outer walls may extend between the first end and the second end of the insulation layer.

According to at least one aspect, the first end of the insulation layer can be recessed with respect to the first end of the body and the second end of the insulation layer can be recessed with respect to the second end of the body.

According to another aspect, at least two insulation layers can be arranged between each body of the one or more battery cells.

According at least one example, the one or more alignment features can define a perimeter that is hexagonal.

### BRIEF DESCRIPTION OF THE DRAWINGS

The drawings described herein are for illustrative purposes only of selected configurations and are not intended to limit the scope of the present disclosure.

FIG. 1 is a front perspective view of a vehicle according to principles of the present disclosure;

FIG. 2 is a top perspective view of a battery cell according to the principles of the present disclosure;

FIG. 3A is a cross-sectional view of the battery cell of FIG. 2;

FIG. 3B is a cross-sectional view of another configuration of a battery cell according to the principles of the present disclosure;

FIG. 3C is a cross-sectional view of another configuration of a battery cell according to the principles of the present disclosure;

FIG. 4 is a top perspective view of a battery module including a base plate and one or more battery cells according to principles of the present disclosure;

FIG. 5 is a top view of the battery module of FIG. 4;

FIG. 6 is a bottom view of the battery module of FIG. 4 with the base plate removed.

FIG. 7A is a front perspective of another configuration of a battery cell according to the principles of the present disclosure;

FIG. 7B is a top view of the battery cell of FIG. 7A;

FIG. 7C is a rear view of the battery cell of FIG. 7A;

FIG. 7D is a front perspective view of a battery module according to the principles of the present disclosure;

FIG. 8A is a front perspective of another configuration of a battery cell according to the principles of the present disclosure;

FIG. 8B is a top view of the battery cell of FIG. 8A;

FIG. 8C is a rear view of the battery cell of FIG. 8A; and

FIG. 8D is a front perspective view of a battery module according to the principles of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Battery cells generate heat during charging and discharging cycles, and excessive heat can lead to thermal runaway, a condition where the temperature of the battery cells increases uncontrollably. Insulation helps to maintain a stable temperature within the battery pack by preventing heat from spreading between cells when one or more neighboring cells enter thermal runaway and release excess heat. Thermal stability is desirable to ensure proper operation of the battery system and to prevent potential hazards such as fires.

Traditionally, an electrically insulative material is applied (e.g., via a film) to cylindrical battery cells before assembling the cells into a battery pack. For instance, a method sometimes referred to as bathtub potting can be used and involves dispensing thermally insulative materials into a cell array. Another method, sometimes referred to as honeycomb insulation, can be used to arrange and insulate several battery cells. In general, honeycomb insulation includes an insulative structure that has several openings or slots that are each configured to receive a battery cell. Ensuring that battery cells are properly and completely insulated with these methods can be time consuming and/or challenging. In accordance with the principles of the present disclosure, assembly of cylindrical battery cells can be streamlined, scrap rate can be minimized, and arcing and thermal runaway events can be mitigated.

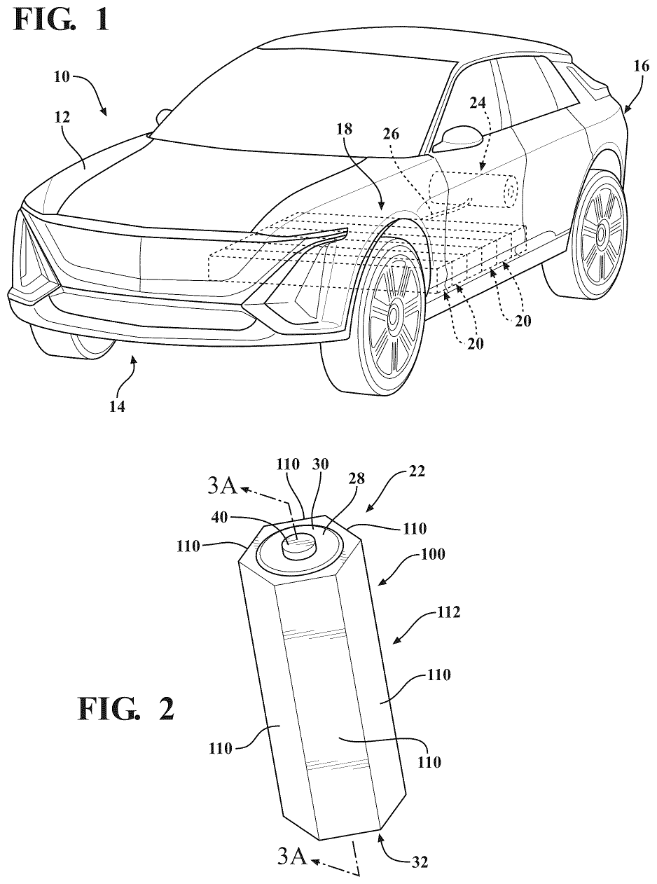

With reference to FIG. 1, an illustrative example of a 10 vehicle is provided. The vehicle 10 has a vehicle body 12 extending between a first end 14 and a second end 16. The vehicle 10 includes a power reservoir (e.g., battery pack) 18 coupled to the vehicle body 12 and has one or more battery modules 20. Each battery module 20 includes one or more battery cells 22 communicatively coupled to one another. The power reservoir 18 is communicatively coupled to an electric motor 24 that is coupled to the vehicle body 12 via a cable 26.

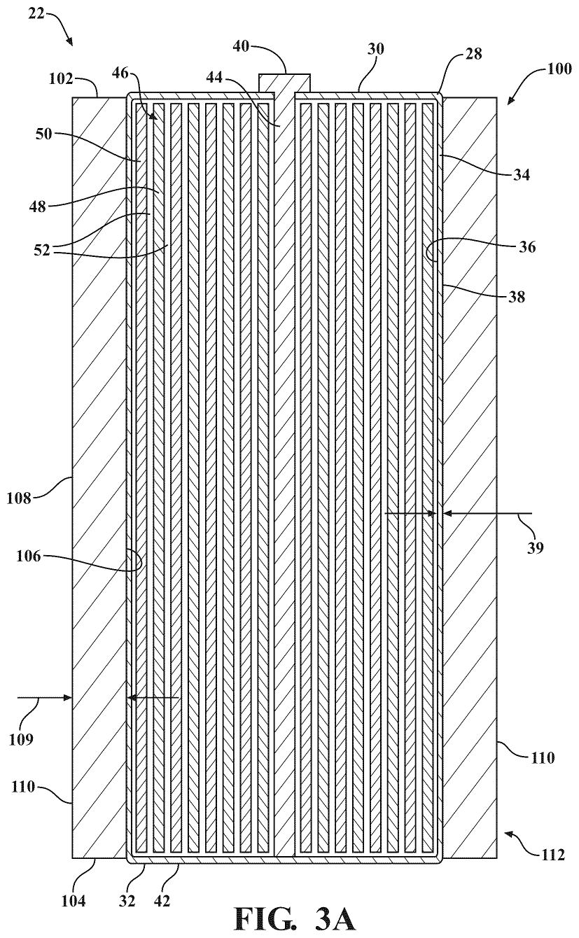

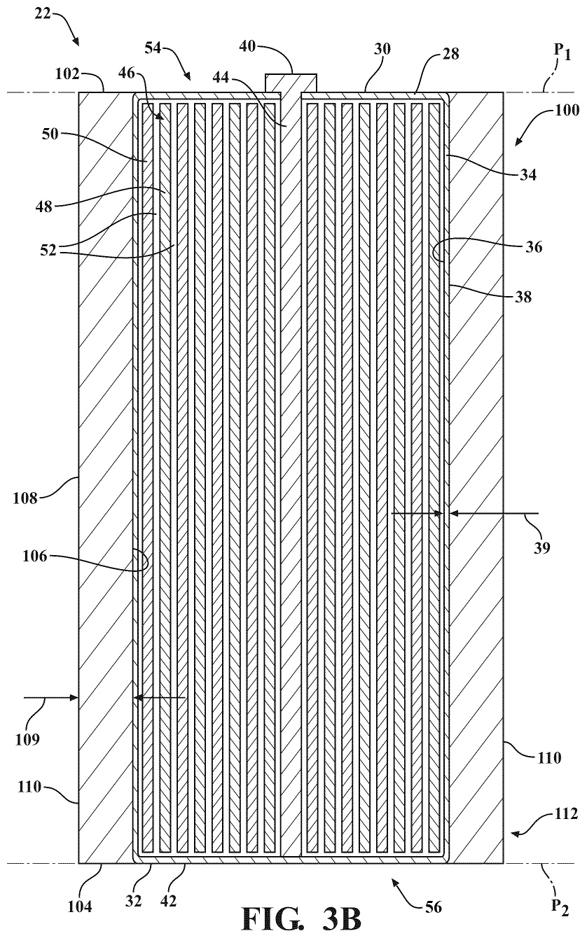

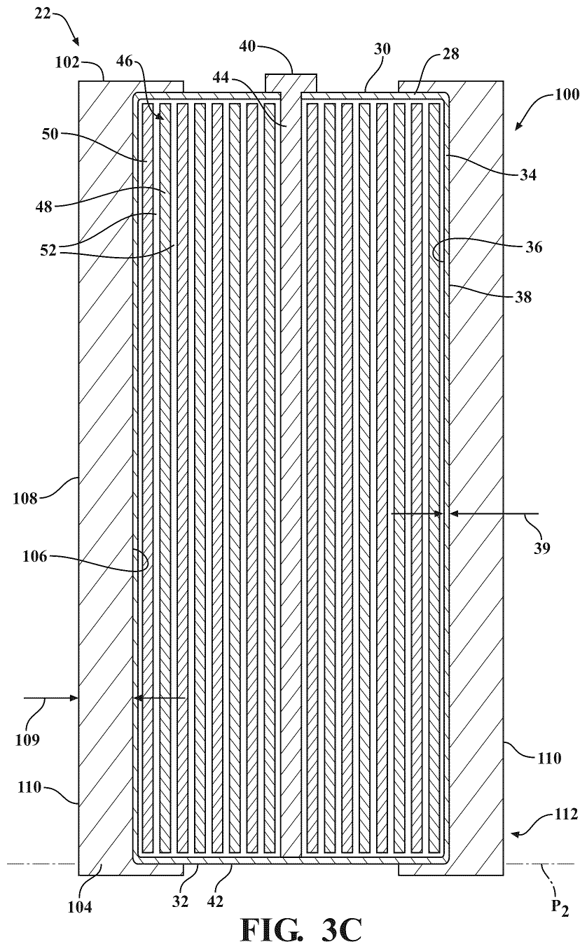

With reference to FIG. 2, an illustrative example of one of the battery cells 22 is provided. The battery cell 22 includes a body or casing 28 that extends between a first end 30 and a second end 32. The body 28 includes a continuous sidewall 34 that extends between the first end 30 and the second end 32 and defines an interior or inner wall 36 and an exterior or outer wall 38 opposite of the inner wall 36, as shown in FIG. 3. A thickness 39 is arranged between the inner wall 36 and the outer wall 38. According to one aspect, the body 28 can be cylindrical, as shown in FIG. 2, or another shape.

With reference to FIG. 3A, the battery cell 22 includes one or more terminals coupled to the body 28, such as a positive terminal 40 at the first end 30 and a negative terminal 42 at the second end 32. Note, in at least one configuration, the positive terminal 40 and the negative terminal 42 can be arranged on the same end (i.e., first end 30 or second end 32) of the battery cell 22. A center pin 44 can be arranged within the body 28 and extend between the first end 30 and the second end 32. Battery internals (i.e., a jelly roll) 46 can be arranged within the body 28 and with respect to the center pin 44. The battery internals 46 can include one or more cathode layers 48, one or more anode layers 50, and one or more separation layers 52 between the one or more cathode layers 48 and the one or more anode layers 50.

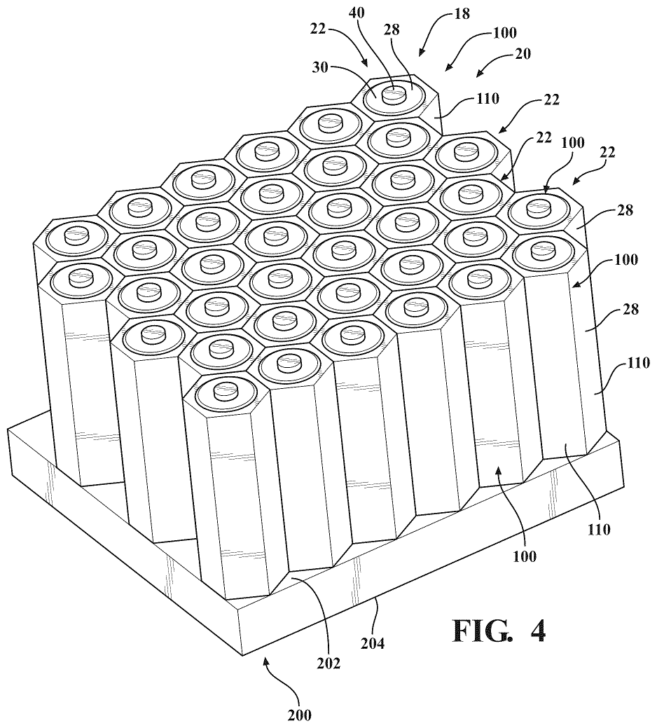

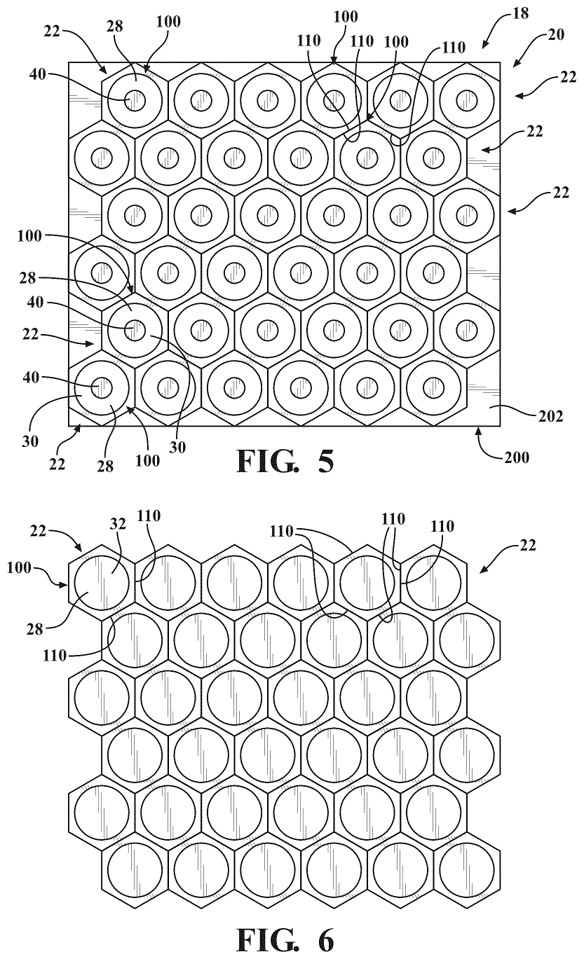

With reference again to FIG. 2, an insulation layer 100 is shown arranged on and/or coupled to the body 28 of the battery cell 22. As discussed in more detail below, the insulation layer 100 can be configured to contact and/or adhere directly to the body 28 of the battery cell 22 and provide thermal insulation and electrical insulation. The insulation layer 100 includes a first end 102 that can be positioned on or adjacent to the first end 30 the body 28 and a second end 104 that can be positioned on or adjacent to the second end 32 of the body 28. The insulation layer 100 includes an inner wall 106 and an outer wall 108 spaced from the inner wall 106. The insulation layer 100 includes a thickness 109 between the inner wall 106 and the outer wall 108. The inner and outer walls 106, 108 extend between the first end 102 and the second end 104. The insulation layer 100 and, more particularly, the outer wall 108 define one or more alignment features or surfaces 110. The one or more alignment features 110 can also be referred to as locating features that can be desirable for positioning two or more of the battery cells 22 with respect to one another. Additionally, alignment features 110 can be configured to correspond with a portion of the battery modules 20 to limit movement of the battery cells 22 upon assembly. According to one aspect, the alignment features 110 can eliminate or reduce the need for additional cell trays or holders that receive and align the battery cells 22. In turn, the alignment features 110 can be desirable for reducing assembly time and/or improving efficiency and productivity. With reference to FIG. 2, the alignment features 110 define a perimeter 112 that is configured to engage with and contact one or more neighboring battery cells 22, as shown in FIGS. 4-5. In the present illustrative configuration, the perimeter 112 includes a hexagon (i.e., six-sided) shape but, in other configurations, the alignment features 110 can define a perimeter with one continuous surface (e.g., circular, oval, tear drop, etc.), at least three sides, four sides, or n-number of sides. The alignment features 110 are substantially planar, flat surfaces that contact and are aligned with alignment features 110 of adjacent battery cells 22. These features 110 help in aligning and maintaining a desired position of adjacent battery cells 22 and, further, aid during assembly of the battery module 20.

In one configuration, with reference to FIG. 3A, the first and second ends 102, 104 of the insulation layer 100 can be recessed with respect to the first and second ends 30, 32 of the body 28. Alternatively, with reference to FIG. 3B, the first end 30 of the body 28 and the first end 102 of the insulation layer 100 can be axially in line with each other and share a first plane P1. Likewise, the second end 32 of the body 28 and the second end 104 of the insulation layer 100 can be axially in line with each other and share a second plane P2. The first end 30 of the body 28 and the first end 102 of the insulation layer 100 define an upper end 54 of the battery cell 22 and the second end 32 of the body 28 and the second end 104 of the insulation layer 100 define a lower end 56 of the battery cell 22. In another configuration, with reference to FIG. 3C, the first and second ends 102, 104 of the insulation layer 100 extend beyond and cover at least a portion of the first end 30 and/or the second end 32 of the body 28. For instance, in at least one configuration, the positive terminal 40 and a portion of the second end 32 of the body 28 remain exposed and not coated or covered with the insulation layer 100.

According to one aspect, the insulation layer 100 can be applied to the body 28 of the battery cell 22 using one or more methods. For instance, the insulation layer 100 can be stretched over the body 28 of the battery cell 22, wrapped around and adhered to the body 28 of the battery cell 22, shrink wrapped around the body 28 of the battery cell, sprayed onto the body 28 of the battery cell 22, and/or rolled onto the body 28 of the battery cell 22. Adhering the insulation layer 100 to the body 28 of the battery cell 22 can be desirable as it provides a protective layer to mitigate a thermal runaway event. In other words, in the event that the sidewall 34 of one of the battery cells 22 ruptures, the insulation layer 100 can contain or prevent the thermal runaway event (i.e., direct gas impingement) from propagating to neighboring battery cells 22.

Individually insulating the battery cells 22 with the insulation layer 100 prior to assembling the battery cells 22 into the power reservoir 18 or one of the battery modules 20 can be desirable because each battery cell 22 can be inspected to ensure the body 28 of each battery cell 22 is completely insulated. Individually insulating the battery cells 22 can also be desirable because it eliminates the need to dispense a material (i.e., a potting material) during the assembly process, which can streamline operations and can reduce material waste.

With reference to FIGS. 4-5, the one or more battery cells 22 can be arranged with respect to one another and with respect to a base plate 200. The base plate 200 includes an upper end 202 and a lower end 204 opposite of the upper end 202. According to one aspect, the base plate 200 can be a cold plate that is configured to support and remove heat from the one or more battery cells 22 during and after operation (e.g., during and after charging and/or load events). The one or more battery cells 22 can be arranged on the upper end 202 of the base plate 200 such that at least two of the insulation layers 100 are arranged between each body 28 of the one or more battery cells 22. With reference to FIGS. 5 and 6, the alignment features 110 of each insulation layer 100 allow the battery cells 22 to be positioned with respect to one another without air gaps or spaces throughout. In other words, the alignment features 110 of one the battery cells 22 can be positioned flush or in complete contact with one or more alignment features 110 of one or more of the neighboring battery cells 22. Individually insulating each of the battery cells 22 with the insulation layer 100 allows the power reservoir 18 and/or one or more of the battery modules 20 to be serviced. According to one aspect, the alignment features 110 of the battery cells 22 allow for one or more of the battery cells 22 to be removed and replaced within the one of the battery modules 20 without disturbing the alignment or insulation layer 100 of neighboring battery cells 22.

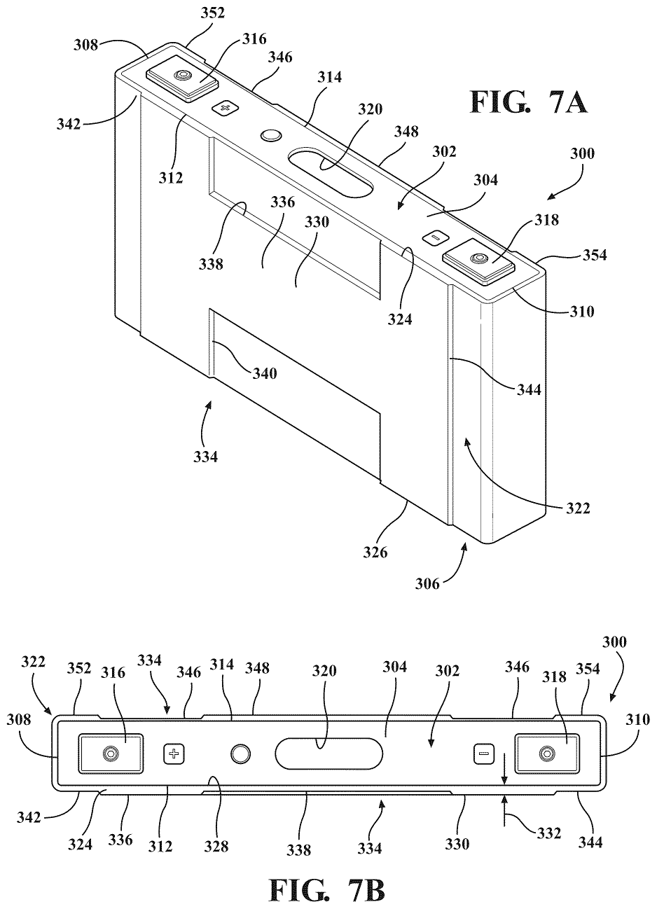

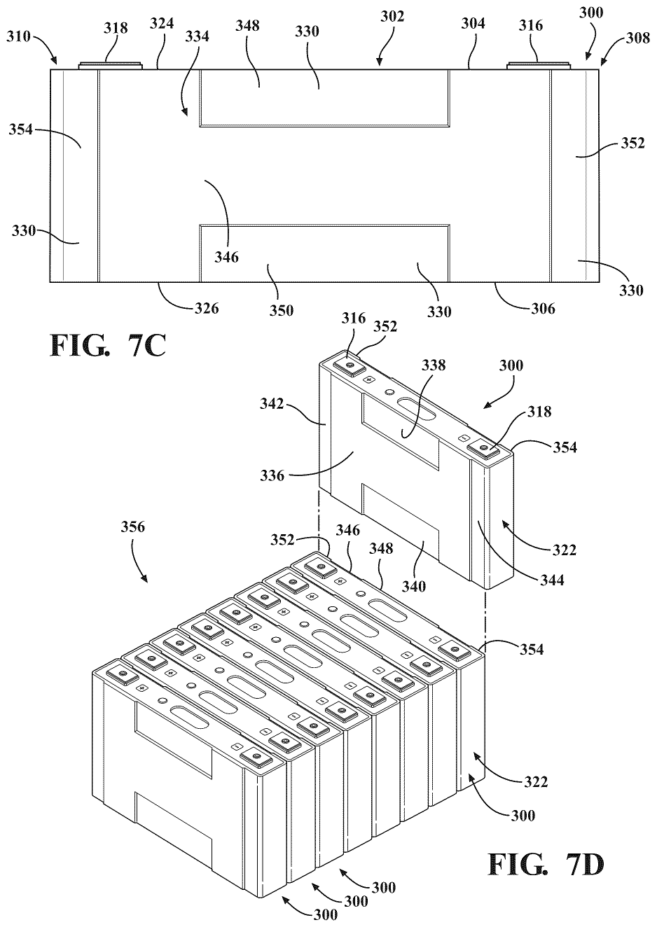

FIGS. 7A, 7B, 7C, and 7D illustrate another illustrative configuration of a battery cell 300. This configuration is similar in many respects to the configuration of FIGS. 1-6. Accordingly, the descriptions of the configurations are hereby incorporated into one another, and description of subject matter common to the configurations generally may not be repeated.

With reference to FIG. 7A, the battery cell 300 includes a prismatic can 302 that extends between a first or upper end 304 and a second or lower end 306. With reference to FIG. 7B, the prismatic can 302 includes one or more side walls, such as a first or left-side wall 308 and a second or right-side wall 310 spaced from the first side wall 308. Additionally, the prismatic can 302 includes a third or front wall 312 and a fourth or rear wall 314. In the present example, the front and rear walls 312, 314 have a length that is longer than that of the first and second side walls 308, 310. The prismatic can 302 is configured to house battery internals, such as one or more jelly rolls (not shown). The battery cell 300 includes terminals coupled to the upper end 304 and in communication with the battery internals. The terminals can include a positive terminal 316 and a negative terminal 318, for example. In the present illustrative example, the prismatic can 302 includes a vent 320 that extends through the upper end 304 and is arranged axially between the positive terminal 316 and the negative terminal 318.

With continued reference to FIG. 7A, the battery cell 300 further includes an insulation layer 322 arranged on and/or coupled to the prismatic can 302. As discussed in more detail below, the insulation layer 322 can be configured to contact and/or adhere directly to the prismatic can 302 of the battery cell 300 and provide thermal insulation and electrical insulation. The insulation layer 322 includes a first end 324 that can be positioned on or adjacent to the first end 304 the prismatic can 302 and a second end 326 that can be positioned on or adjacent to the second end 306 of the prismatic can 302. The insulation layer 322 includes an inner wall 328 and an outer wall 330 spaced from the inner wall 328. The insulation layer 322 includes a thickness 332 between the inner wall 328 and outer wall 330. The inner and outer walls 328, 330 extend between the first end 324 and the second end 326.

The insulation layer 322 includes one or more alignment features 334. The one or more alignment features 334 can also be referred to as locating features that are configured to quickly position two or more of the battery cells 300 with respect to one another. In turn, the alignment features 334 can be desirable for reducing assembly time and/or improving efficiency and productivity. In the present illustrative configuration, the one or more alignment features 334 include one or more receptacles and one or more projections that are positioned with respect to the front and rear walls 312, 314 of the prismatic can 302. According to one aspect, the alignment features 334 arranged with respect to the front wall 312 can be opposite of those arranged with respect to the rear wall 314. This can be desirable so that the alignment features of one battery cell 300 can mate with the alignment features 334 of a neighboring battery cell 300, as shown in FIG. 7D. With reference to FIG. 7A, the alignment features 334 arranged with respect to the front wall 312 include a front projection 336 that defines a portion of the outer wall 330 and defines a first or upper front receptacle 338, a second or lower front receptacle 340 spaced from the upper front receptacle 338, a third front receptacle 342, and a fourth front receptacle 344 spaced from the third front receptacle 342. With reference to FIG. 7C, the alignment features 334 arranged with respect to the rear wall 314 include a rear receptacle 346 that defines a first or upper rear projection 348, a second or lower rear projection 350 spaced from the upper rear projection 348, a third rear projection 352, and a fourth rear projection 354 spaced from the third rear projection 352. At least one of the first, second, third, and fourth rear projections 348, 350, 352, 354 define at least a portion of the outer wall 330.

The battery cells 300 can be assembled with respect to one another to form a battery module 356. When the front projection 336 of one of the battery cells 300 mates with the rear receptacle 346 of a neighboring battery cell 300, the battery cells 300 are constrained with respect to one another. In other words, the battery cells 300 are constrained with respect to at least two axes when the first front receptacle 338, the second front receptacle 340, the third front receptacle 342, and the fourth front receptacle 344 of one battery cell 300 respectively mates with (i.e., receives) the first rear projection 348, the second rear projection 350, the third rear projection 352, and the fourth rear projection 354.

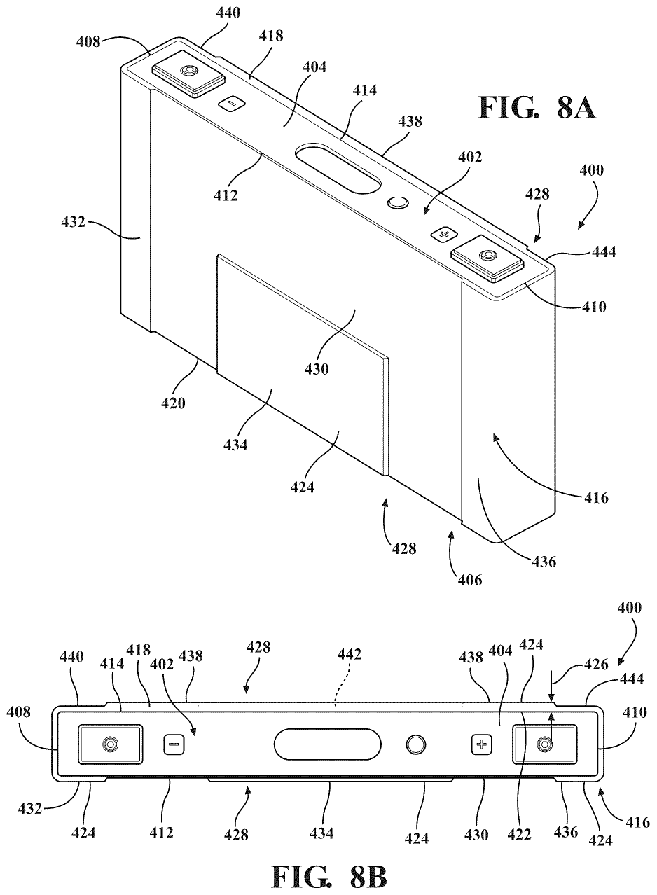

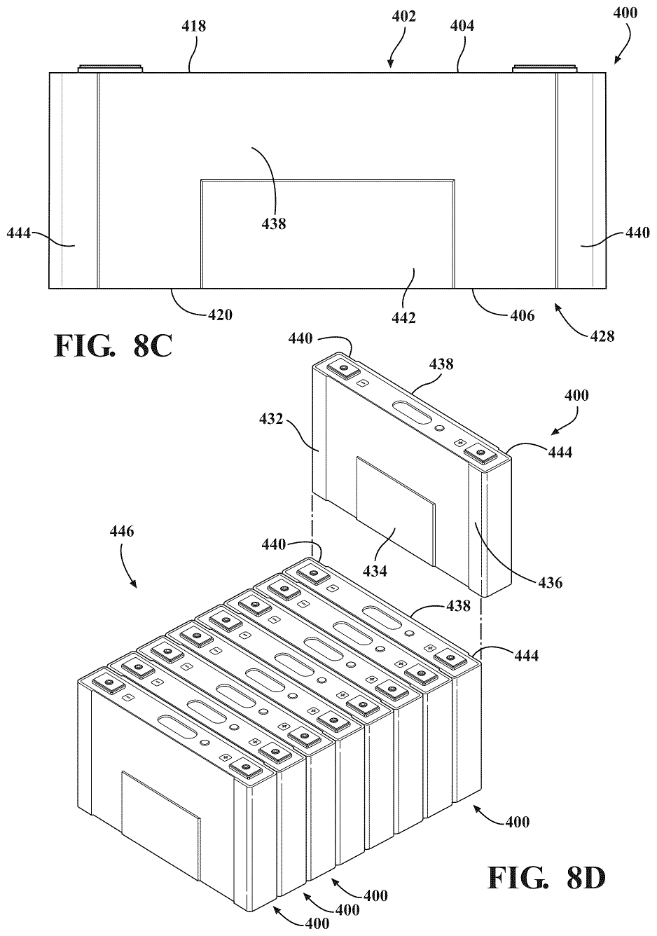

FIGS. 8A, 8B, 8C, and 8D illustrate an illustrative configuration of a battery cell 400. This configuration is similar in many respects to the configuration of FIGS. 1-6 and FIGS. 7A-7D. Accordingly, the descriptions of the configurations are hereby incorporated into one another, and description of subject matter common to the configurations generally may not be repeated.

With reference to FIG. 8A, the battery cell 400 includes a prismatic can 402 that extends between a first or upper end 404 and a second or lower end 406. With reference to FIG. 8B, the prismatic can 402 includes one or more side walls, such as a first or left-side wall 408 and a second or right-side wall 410 spaced from the first side wall 408. Additionally, the prismatic can 402 includes a third or front wall 412 and a fourth or rear wall 414.

With reference again to FIGS. 8A-8D, the battery cell 400 further includes an insulation layer 416 shown arranged on and/or coupled to the prismatic can 402. As discussed in more detail below, the insulation layer 416 can be configured to contact and/or adhere directly to the prismatic can 402 of the battery cell 400 and provide thermal insulation and electrical insulation. The insulation layer 416 includes a first end 418 that can be positioned on or adjacent to the first end 404 the prismatic can 402 and a second end 420 that can be positioned on or adjacent to the second end 406 of the prismatic can 402. The insulation layer 416 includes an inner wall 422 and an outer wall 424 spaced from the inner wall 422. The insulation layer 416 includes a thickness 426 between the inner wall 422 and outer wall 424. The inner and outer walls 422, 424 extend between the first end 418 and the second end 420.

The insulation layer 416 includes one or more alignment features 428. The one or more alignment features 428 can also be referred to as locating features that are configured to quickly position two or more of the battery cells 400 with respect to one another. In turn, the alignment features 428 can be desirable for reducing assembly time and/or improving efficiency and productivity. In the present illustrative configuration, the one or more alignment features 428 include one or more receptacles and one or more projections that are positioned with respect to the front and rear walls 412, 414 of the prismatic can 402. According to one aspect, the alignment features 428 arranged with respect to the front wall 412 can be opposite of those arranged with respect to the rear wall 414. This can be desirable so that the alignment features 428 of one battery cell 400 can mate with (i.e., receive) the alignment features 428 of a neighboring battery cell 400, as shown in FIG. 8D. With reference to FIG. 8A, the alignment features 428 arranged with respect to the front wall 412 include a front receptacle 430 that defines a first front projection 432 extending between the first end 418 and the second end 420, a second front projection 434 extending from the second end 420 toward the first end 418, and a third front projection 436 extending between the first end 418 and the second end 420. The first front projection 432, the second front projection 434, and/or the third front projection 436 define at least a portion of the outer wall 424. With reference to FIG. 8C, the alignment features 428 arranged with respect to the rear wall 414 include a rear projection 438 that defines a first rear receptacle 440 extending between the first end 418 and the second end 420, a second rear receptacle 442 extending from the second end 420 toward the first end 418, and a third rear receptacle 444 extending between the first end 418 and the second end 420. The rear projection 438 defines at least a portion of the outer wall 424.

The battery cells 400 can be assembled with respect to one another to form a battery module 446. When the front receptacle 430 of one of the battery cells 400 mates with the rear projection 438 of a neighboring battery cell 400, the battery cells are constrained with respect to one another. In other words, the battery cells 400 are constrained with respect to at least one axis when the first front projection 432, the second front projection 434, and the third front projection 436 respectively mate with the first rear receptacle 440, the second rear receptacle 442, and the third rear receptacle 444. According to one aspect, the alignment features 428 can be configured so that one of the battery cells 400 can be swapped out of the battery module 446 without disrupting the other battery cells 400 in the battery module 446.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A battery cell, comprising:
a body extending between a first end and a second end;
battery internals arranged in the body; and
an insulation layer arranged on the body and extending between the first end and the second end, the insulation layer including one or more alignment features.

2. The battery cell of claim 1, wherein the body includes a positive terminal and a negative terminal.

3. The battery cell of claim 2, wherein the battery internals include one or more cathode layers, one or more anode layers, and one or more separation layers arranged about a center pin that is arranged in the body and extends between the first end and the second end.

4. The battery cell of claim 2, wherein the insulation layer further includes a first end and a second end spaced from the first end, and an inner wall and an outer wall spaced from the inner wall, the inner and outer walls extending between the first end and the second end of the insulation layer.

5. The battery cell of claim 4, wherein the one or more alignment features define a perimeter of the battery cell that is hexagonal.

6. The battery cell of claim 4, wherein the first end of the insulation layer is recessed with respect to the first end of the body and the second end of the insulation layer is recessed with respect to the second end of the body.

7. The battery cell of claim 4, wherein the first end of the insulation layer overlaps a portion of the first end of the body and the second end of the insulation layer overlaps a portion of the second end of the body.

8. The battery cell of claim 4, wherein the first end of the insulation layer shares a first plane with the first end of the body and the second end of the insulation layer shares a second plane with the second end of the body.

9. The battery cell of claim 1, wherein the alignment features of the insulation layer include at least three sides.

10. The battery cell of claim 1, wherein the alignment features of the insulation layer define a perimeter that includes one continuous surface.

11. A battery module, comprising:
a base plate including an upper end and a lower end opposite of the upper end; and
one or more battery cells arranged on the upper end, the one or more battery cells including:
a body extending between a first end and a second end and including a sidewall that extends between the first end and the second end,
battery internals arranged in the body, and
an insulation layer arranged on the body and extending between the first end and the second end, the insulation layer including one or more alignment features.

12. The battery module of claim 11, wherein the insulation layer further includes a first end and a second end spaced from the first end, and an inner wall and an outer wall spaced from the inner wall, the inner and outer walls extending between the first end and the second end of the insulation layer.

13. The battery module of claim 12, wherein the first end of the insulation layer is recessed with respect to the first end of the body and the second end of the insulation layer is recessed with respect to the second end of the body.

14. The battery module of claim 12, wherein the first end of the insulation layer overlaps a portion of the first end of the body and the second end of the insulation layer overlaps a portion of the second end of the body.

15. The battery module of claim 12, wherein the first end of the insulation layer shares a first plane with the first end of the body and the second end of the insulation layer shares a second plane with the second end of the body.

16. A vehicle, comprising:
a vehicle body extending between a first end and a second end;
an electric motor coupled to the vehicle body; and
a power reservoir coupled to the vehicle body and communicatively coupled to the electric motor, the power reservoir including:
one or more battery modules; and
one or more battery cells arranged in each of the one or more battery modules, the one or more battery cells each comprising:
a body extending between a first end and a second end and including a sidewall that extends between the first end and the second end,
battery internals arranged in the body, and
an insulation layer arranged on the body and extending between the first end and the second end, the insulation layer including one or more alignment features.

17. The vehicle of claim 16, wherein the insulation layer further includes a first end and a second end spaced from the first end, and an inner wall and an outer wall spaced from the inner wall, the inner and outer walls extending between the first end and the second end of the insulation layer.

18. The vehicle of claim 17, wherein the first end of the insulation layer is recessed with respect to the first end of the body and the second end of the insulation layer is recessed with respect to the second end of the body.

19. The vehicle of claim 16, wherein at least two insulation layers are arranged between each body of the one or more battery cells.

20. The vehicle of claim 16, wherein the one or more alignment features define a perimeter that is hexagonal.
